(19) United States
(12) Patent Application Publication
(10) Pub. No.: US 2009/0197787 A1
(43) Pub. Date: Aug. 6, 2009

(54) Multilayer Detergent Tablet

(75) Inventors: Valerie Venet, Saint Galmier (FR); Murielle Moneron, St Just St Rambert (FR); Jacques Brosse, La Grand Croix (FR); Gilles Rubinstenn, Paris (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Eurotab

(21) Appl. No.: 12/025,251

(22) Filed: Feb. 4, 2008

(51) Int. Cl. C11D 17/00; B05D 3/12

(52) U.S. Cl. 510/224; 510/298; 427/369

(57) ABSTRACT

The invention relates to a detergent tablet characterized in that it comprises five layers superimposed on each other, with at least three layers among the five layers having different compositions. The invention also relates to a method for manufacturing such a detergent tablet.

### FIELD OF THE INVENTION

The present invention relates to the field of detergent compositions in the form of tablets. These detergent tablets are intended to be used in appliances such as dishwashers or washing machines for cleaning dishes or laundry, respectively.

### STATE OF THE ART

Different kinds of detergent compositions are known for washing dishes in a dishwasher such as powders or liquids for dishwashers, the required amount of which is measured by the consumer which places them in the dispenser of said dishwasher. This type of packaging is not very satisfactory insofar that the consumer uses a too small or too large amount of powder or liquid, thereby leading either to bad washing or over-consumption of products.

In order to facilitate the use of these detergent compositions and to improve storage conditions, it was proposed to package them as tablets. These detergent tablets were first monolayer tablets, consisting of a mixture of components such as bleaching agents, enzymes, detergency adjuvants, etc. However, monolayer tablets have the drawback of leading to uncontrolled dissolution of the components depending on the selected cycle and on the washing temperature. With this type of system it is therefore not possible to separate the actions of the different components of the tablets and to provide efficient washing and rinsing of the items to be cleaned.

Accordingly tablets comprising two, or even three, superimposed layers were proposed, so as to separate certain compounds in order to avoid their action at the same time during the washing cycle. It was even proposed to add a central insert in order to possibly use an additional composition. If such tablets allow physical separation of certain components, this separation is not complete and the latter components may interact, in particular during storage of the tablets. In addition, the tablets lose mechanical strength, in particular when a central insert is used, which is a major drawback for storing and transporting tablets.

Phosphate-free detergent tablets (i.e. tablets containing less than 4% of phosphates) are increasingly used today, in particular for reducing pollution of waters. Now, phosphate-free detergent tablets having two or three layers are difficult to carry out because they have lower breaking strength than tablets containing a large amount of phosphates (typically 30%). Pelletizing additives such as binders are therefore generally added to the phosphate-free tablets or to those containing less than 4% of phosphates in order to improve their cohesion, which is disadvantageous, in particular because the industrial manufacturing process becomes more complex.

An object of the present invention is therefore to propose a detergent tablet for solving at least one of the aforementioned drawbacks, as well as to an associated manufacturing method.

In particular, an object of the present invention is to propose a detergent tablet and an associated manufacturing method, having large impact resistance whether this tablet is with or without phosphate.

Another object of the present invention is to propose a detergent tablet, and an associated manufacturing method, having increased chemical resistance thereby improving its stability during storage.

Still another object of the present invention is to propose a detergent tablet, and an associated manufacturing method, allowing controlled and fine dissolution of the components depending on the selected cycle and on the washing temperature.

### DISCUSSION OF THE INVENTION

To this end is provided a detergent tablet, characterized in that it comprises five superimposed layers on each other, with at least three layers among the five layers having different compositions.

Preferred but non-limiting aspects of this detergent tablet are the following aspects:
the detergent tablet has a mass between 15 and 30 grams, preferably between 18 and 25 grams;
the detergent tablet has a height between 5 and 50 mm, preferably between 10 and 30 mm;
the detergent tablet has a height between 1 and 20 mm, preferably between 1 and 10 mm;
the detergent tablet has a breaking strength between 70 and 180 Newtons, preferably between 80 and 150 Newtons;
the detergent tablet has a density between 1 and 5 g/cm³;
the detergent tablet comprises less than 4% by mass of phosphates, the mass percentage being relative to the total mass of the tablet;
the detergent tablet comprises:
   between 0.003 and 2% by mass of active enzymes;
   between 10 and 99% by mass of detergency adjuvants, preferably between 30 and 70% by mass;
   between 0.05 and 40% by mass of surfactants, preferably between 1 and 25% by mass, and still preferably between 1 and 5% by mass;
   between 1 and 30% by mass of bleaching agents, preferably between 5 and 20% by mass;
   between 0.5 and 10% by mass of bleaching agent activators, preferably between 1 and 5% by mass,
   the mass percentages being relative to the total mass of the tablet.
the three layers having different compositions comprise a bleaching agent, a bleaching agent activator, and enzymes for forming an enzymatic system, respectively;
the layer comprising the enzymes is not in contact with the layer comprising the bleaching agent, and the layer comprising the bleaching agent is not in contact with the layer comprising the bleaching agent activator;
the detergent tablet further comprises rinsing additives in order to form a rinsing system, and protective additives for forming a system for protecting items to be cleaned with the detergent tablet;
the detergent tablet comprises one or two layers having a bleaching agent;
each of the five layers has a different composition, the five layers comprising the bleaching agent, the bleaching agent activator, the enzymes, the rinsing additives, and the protective additives, respectively;
the detergent tablet comprises a layer with a disintegration time of less than 7 minutes and a layer with a disintegration time of more than 7 minutes;
the layer having a disintegration time of less than 7 minutes is the layer forming the enzymatic system, the layer forming the enzymatic system preferably comprising disintegrating agents for accelerating disintegration of the layer;
the layer having a disintegration time of more than 7 minutes is the layer forming the rinsing system, the layer forming the rinsing system preferably comprising retarding agents for slowing down the disintegration of the layer.

According to another aspect of the invention is provided a method for manufacturing this detergent tablet, this method comprising the following successive steps:
Forming the mixtures corresponding to the respective compositions of the five layers of the tablet;
depositing on a support the mixture corresponding to the composition of the first layer, and forming the first layer by compression;
depositing on the first layer the mixture corresponding to the composition of the second layer, and forming the second layer by compressing the formed assembly;
depositing on the second layer the mixture corresponding to the composition of the third layer, and forming the third layer by compressing the formed assembly;
depositing on the third layer the mixture corresponding to the composition of the fourth layer, and forming the fourth layer by compressing the formed assembly;
depositing on the fourth layer the mixture corresponding to the composition of the fifth layer, and forming the fifth layer by compressing the formed assembly.

Preferably the formation of the first, second, third and fourth layers is achieved by compressing the formed assembly at a compression value comprised between 1,000 kN/m² and 10,000 kN/m², and in that the formation of the fifth layer is achieved by compressing the formed assembly at a compression value comprised between 8,000 kN/m² et 25,000 kN/m².

### DESCRIPTION OF THE FIGURES

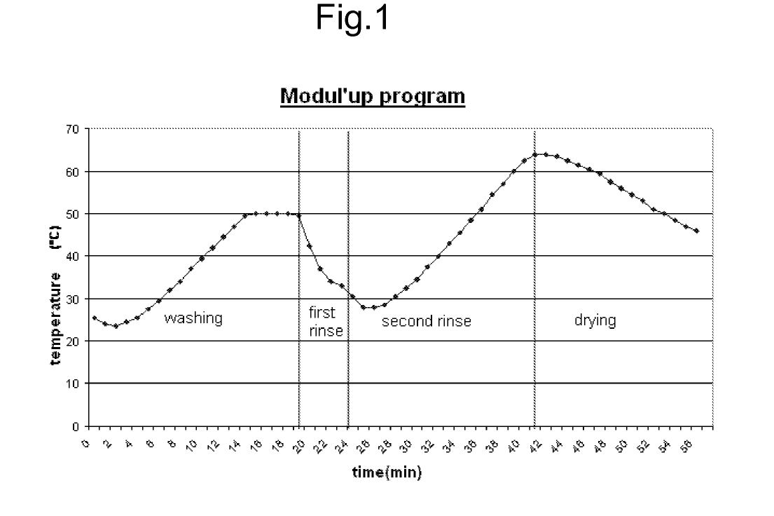

Other features and advantages of the invention will further be apparent from the description which follows, which is purely illustrative and non-limiting and should be read with reference to the appended drawings, wherein FIG. 1 is a graph illustrating the washing cycle of the dishwasher used for testing the performances of the detergent tablet.

### DETAILED DESCRIPTION OF THE INVENTION

The detailed description which follows is made with reference to a detergent tablet adapted so as to be used in a dishwasher for cleaning dishes. However, the corresponding teaching may easily be adapted by one skilled in the art so that the detergent tablet may be used in a washing machine; the compositions of the different layers should in particular be changed in order to have them correspond to the sought-after active ingredients.

The detergent tablet of the invention consists of a stack of five layers which are superimposed on each other, thereby forming a uniform and compact block.

The tablet has a circular shape with a section having any shape, generally a circular, oval, octogonal, or parallelepipedal shape. When the section of the tablet is parallelepipedal, typically square or rectangular, the corners of the tablet may be rounded so that they are less brittle.

Each of the layers has the same section so that the formed stack is uniform. In particular, the side surfaces of the layers are straight, the side surfaces of the adjacent layers being preferentially contiguous so that the edge of the tablet is continuous. In particular, this avoids having side shifts between two successive layers, these shifts generally having a detrimental effect on the mechanical stability of the tablet during handling operations, for example.

Each layer has a height comprised between 1 and 20 mm, and preferentially between 1 and 10 mm. It is not mandatory that the five layers have an identical height even if this is preferred. The detergent tablet has a total height comprised between 5 and 50 mm, preferably between 10 and 30 mm. The detergent tablet further has a mass comprised between 15 and 30 grams, preferably between 18 and 25 grams, and a density comprised between 1 and 5 g/cm³. In the case of a detergent tablet for a washing machine, the mass may be comprised between 15 and 45 grams (density comprised between 1 and 5 g/cm³).

The five layer tablet shown thus has a simple shape and dimensions which increase its mechanical resistivity since protruding points are reduced to a maximum. Such a detergent tablet actually has a breaking strength between 70 and 180 Newtons, preferably between 80 and 150 Newtons.

Mechanical strength of the tablet is also achieved by the manufacturing process that is carried out, which consists of gradually forming a complex of several layers, and of compacting this complex at each new addition of layer so as to solidify it.

As this will be seen in detail subsequently, the tablet comprises at least three layers having different compositions. The first step therefore consists of mixing the components intended to form the compositions corresponding to each of the layers.

The mixture corresponding to the first layer should then be deposited on a support, or in a mold with the desired section, and then the mixture should be packed in order to form the first layer.

The mixture corresponding to the second layer is then deposited on the first layer, and the assembly is compressed in order to form a first complex comprising the first and the second layer.

In the same way for the third, fourth and fifth layers, the corresponding mixture is deposited on the complex formed in the preceding step and the assembly is compressed in order to obtain a new complex with an additional layer.

The compression forces used for forming the first, second, third and fourth layers are comprised between 1,000 kN/m² and 10,000 kN/m². The final applied compression force, upon forming the fifth layer, is larger, comprised between 8,000 kN/m² and 25,000 kN/m², so as to increase the cohesion and the global strength of the tablet.

With this manufacturing process, it is possible to reinforce the detergent tablet which offers increased impact resistance. Further, when phosphorus-free tablets are produced, it is unnecessary to add any additive for reinforcing the stability of the tablet, which is particularly advantageous.

In addition to the advantages related to the physical structure of the five-layer tablet mentioned here, this detergent tablet also benefits from many advantages of its chemical structure, in particular as regards its stability and its efficiency during washing.

In order to obtain a tablet both chemically stable and efficient, which in particular allows fine sequenced dissolution of the components, the tablet should be designed by imposing the two following constraints.

The first requirement is to place in different layers the components which will have to act at different moments during the relevant washing cycle. This therefore leads to adding several layers of different compositions in a same tablet.

It is also appropriate to maximally separate the compositions which are incompatible with each other from a chemical stability point of view. During storage phases, there may actually be undesired interactions between certain components of adjacent layers. It is therefore appropriate to maximally separate these components from each other in order to reduce the corresponding interactions to a maximum.

In a detergent tablet, there are at least two components which preferably should not react with each other. In a five-layer tablet with at least three layers having a different composition, it is thus possible to separate the layers comprising the components not to be put into contact, by means of an intermediate layer with a different composition.

The chemical structure of the tablet is therefore determined by meeting as much as possible these constraints which will guarantee the quality of the tablet.

A detergent tablet for a dishwasher comprises a certain number of components which will be explained in more detail here, without limitation.

### Enzymes

In order to allow degradation of the dirt present on the dishes, the tablet should contain enzymes of the protease, amylase type and optionally of the lipase type which form what is called an enzymatic system. These enzymes generally appear as granules which contain a certain amount of active enzymes.

The detergent tablets according to the invention have a global composition integrating enzymes including the total amount of active enzymes which is comprised between 0.003 and 2% by mass. The mass percentages indicated here and in the remainder of the document are based on the total mass of the composition of the tablet.

Amylases may be used for decomposing starch-based stains. Stainzym 12T (trademark registered by the Novozymes company, Copenhagen, Denmark) and/or Stainzym plus 12T (registered trademark) produced and distributed by Novozymes (registered trademark) and/or Purastar OXAM 8000E (registered trademark) produced and distributed by Genencor International (registered trademark) may be used. Stainzym 12T and Stainzym plus 12T are sold as granules and comprise 1.4% of active enzymes. Purastar OXAM 8000E is also sold as granules and comprises from 5.2 to 5.8% of active enzymes.

The tablet may also contain proteases for acting on protein stains such as meat and eggs. Ovozyme 64T (registered trademark) produced and distributed by Novozymes and/or Purafect OX 8000D (registered trademark) produced and distributed by Genencor International may be used in the present invention. These enzymes are sold as granules, Ovozyme 64T comprising 8.6% of active enzymes and Purafect OX 8000D comprising from 10 to 12% of active enzymes.

The tablet may also contain lipases in order to improve degradation of fat stains present on the dishes. Lipex 100 (registered trademark) produced and distributed by Novozymes may for example be used.

### Bleaching Agents and Bleaching Agent Activators

In order to allow degradation of oxidizable stains such as tea, coffee, red wine, the tablet may contain a bleaching agent, i.e. a substance capable of directly or indirectly oxidizing the described organic compounds.

The bleaching agents may therefore be of the sodium perborate mono or tetra-hydrate, sodium percarbonate, sodium persilicate and sodium persulfate. In an alkaline environment, these compounds release hydrogen peroxide in contact with water thereby generating a source of active oxygen.

The tablet comprises between 1 and 30% of bleaching agents, preferably between 5 and 20%.

In order to allow an even more efficient whitening of the dishes, the tablet should contain a bleaching agent activator of the tetra-acetylene diamine (TAED), pentaacetylglucose (PAG), tetra-acetylglycoluryl (TAGU) and sodium benzoyloxybenzene-sulfonate type. These activators react in the wash with hydrogen peroxide, giving chemical compounds for which performance on organic dirt is superior, in particular for reasons of chemical affinity.

The tablet comprises between 0.5 and 10% of bleaching agent activator, preferably between 1 and 5%.

Preferably, the tablet comprises a ratio between bleaching agents and bleaching agent activators corresponding to a molar ratio of 4 for 1, preferably a molar ratio of 2 for

### Detergency Adjuvants (or <<Builders>>)

Efficiency of the washing is increased if the tablet further comprises detergency adjuvants which are also called <<builders>>. The detergency adjuvants entrap metal ions such as calcium and magnesium ions present in the washing solution by complexation, ion exchange or precipitation.

When a detergency adjuvant is present, it is present in an amount generally comprised between 10 and 99% by mass, preferably between 30 and 70% by mass.

The phosphorus-free water-soluble detergency adjuvants may be organic or inorganic. The inorganic compounds which may be present, comprise zeolites, phyllosilicates, alkaline metal (generally sodium) carbonates, and sodium silicates; while the organic compounds comprise polycarboxylate polymers such as polyacrylates, acrylic-maleic copolymers and acrylic phosphonates, monomeric polycarboxylates such as citrates, gluconates, oxydisuccinates, glycerol mono-, di- and tri-succinates, carboxymethyloxysuccinates, amino polycarboxylic compounds (such as methyl-glycine-diacetic acid carboxymethyloxymalonates), dipicolinates, nitrilotriacetates and hydroxyethylimino-diacetates.

The class of phosphorus-containing water soluble adjuvants comprises alkaline metal orthophosphates, metaphosphates, pyrophosphates and poly-phosphates. Specific examples of inorganic phosphate detergency adjuvants comprise sodium and potassium tripolyphosphates, orthophosphates and hexametaphosphates. Sodium tripolyphosphate is a particularly preferred phosphorus adjuvant for dishwasher tablets. It exists in a hydrated, anhydrous or partially hydrated form, and mixtures of these forms may be used for controlling the disintegration and dissolution rate of the tablet. The contents of these additives capable of leading to the release of phosphate in river waters with a resulting trophic effect are preferably restricted to a level less than 4% by mass in the tablet.

In order to allow efficient washing of the dishes, the pH of the washing solution should be at least 9 and preferably between 9.5 and 12.5. Most detergency adjuvants are alkaline, so that it is not necessary to add other compounds to the tablet for adjusting the pH. If this is not the case, it is preferable that the tablet comprise components with which the pH of the washing solution may be adjusted between 9.5 and 12.5.

### Surfactants

In order to allow efficient washing, the tablet should contain one or more non-ionic surfactants, preferably low-foaming non-ionic surfactants. Surfactants are amphiphilic molecules which consist of an apolar lipophilic portion and of a polar hydrophilic portion.

For dishwasher detergent tablets, the amount of surfactants in the tablet is comprised between 0.05 and 15% by mass and preferably between 1 and 5% by mass.

Surfactants in the solid form are easier to use in the tablets which also have solid compositions. However, when the surfactant is in the liquid form, it may also be introduced into the tablet, in which case it is adsorbed on supports such as sodium carbonate or silica.

Synthetic non-ionic surfactants may generally be defined as compounds derived from condensation between alkylene oxide groups and hydrophobic organic compounds which may be aliphatic or aromatic. The length of the hydrophilic portion of the surfactant may easily be adjusted in order to obtain a water-soluble compound having the desired HLB, HLB expressing hydrophilicity or lipophilicity of the surfactant.

The non-exhaustive list of non-ionic surfactants which may be used in the tablet, groups together ethoxylated and/or propoxylated fatty alcohols, ethylene oxide and propylene oxide copolymers, and alkyl polyglucosides.

The ethoxylated and/or propoxylated fatty alcohols are derived from condensation between a polyethylene oxide and/or polypropylene oxide chain with a fatty alcohol. The ethoxylated and/or propoxylated fatty alcohols may be linear, branched, saturated or unsaturated, and may contain about 6 to 24 carbon atoms and about 5 to 50 ethylene oxide and/or propylene oxide units. Lauric alcohol, myristic alcohols are fatty alcohols which may be used in the desired detergent tablet. Non-ionic surfactants of the <<Genapol>> (registered trademark) type, produced by Clariant (registered trademark) may be used and more particularly the non-ionic surfactant marketed as Genapol EP 2544 (C12/C15, 4EO/4PO).

Polyethylene oxide groups account for at least 40% of the block copolymer. The compounds generally have a molecular weight from about 2,000 to 10,000, and preferably from about 3,000 to 6,000. The surfactants of the <<Pluronic>> type from BASF may for example be used in this present invention.

Alkyl polyglucosides (AGP) are easily biodegradable and may be used in the compositions for dishwasher tablets. The surfactants of the <<Glucopon>> (registered trademark) type from Cognis (registered trademark) may for example be used in the desired detergent tablet, and more particularly the non-ionic surfactant marketed as Glucopon 50G.

It is also possible to use anionic surfactants, in particular for the case of detergent tablets for washing machines. In this case, the amount of surfactants in the tablet is comprised between 0.05 and 40% by mass, and preferably between 5 and 25% by mass.

The non-exhaustive list of anionic surfactants which may be used in the detergent tablets for washing machines groups together alkylbenzene sulfonates, paraffin or alkane sulfonates, primary alcohol sulfates, a-olefinsulfonates, alkyl ether sulfates, sulfosuccinates, acyl isethionates, methyl ester sulfonates, soap, fatty acid sulfoalkylamides, diglycolamide sulfates, N-acyl amino acids, and alkyl polyoxyethylene carboxylates.

Sodium alkylsulfates of the <<Sulfopon>> (registered trademark) type produced by Cognis (registered trademark) may be used in the desired detergent tablet, and more particularly the anionic surfactants marketed as <<Sulfopon 1218 G>> and <<Sulfopon 1216 G>>.

Soaps may also be used in the tablet and more particularly the soap marketed as <<Trepalbe PC20P 86%>> produced by Christeyns (registered trademark).

### Complementary Components

In addition to these basic components of the detergent tablet, the latter may comprise complementary components which will be used depending on the desired specificities of the detergent tablet.

For example rinsing additives may be used, such as surfactants and chelating agents, which allow the formation of a rinsing system involved in the final phase, after using the cleaning agents.

Protective additives may also be used, for example benzotriazole and zinc salts. These protective additives form a system for protecting the dishes and the dishwasher against undesired chemical etchings from any of the components of the tablet.

Dyes may also be added in order to differentiate the layers relatively to each other. These dyes essentially have the purpose of improving the aesthetical aspect of the tablet for the consumer.

The amount of dye in the tablet is in this case comprised between 0.01 and 0.15% by mass, preferably between 0.01 and 0.1% by mass.

Chelating agents intended for entrapping metal ions may also be present in the composition. They are also called metal ion sequestering or complexing agents. If necessary, it is preferable that the amount of chelating agents be of the order of 0.5 to 5% by mass.

The preferred chelating agents comprise organic phosphonates, aminocarboxylates, compounds substituted in a polyfunctional way and their mixtures. Homopolymers of acrylic acid or copolymers of acrylic and maleic acid may also be used.

More preferred chelating agents are organic phosphonates such as alpha-hydroxy-2-phenyl-ethyl diphosphonate, ethylene diphosphonate, hydroxyl-1,1-hexylidene, vinylidene-1,1-diphosphonate, 1,2-dihydroxyethane 1,1-diphosphonate and hydroxyethylene 1,1-diphosphonate. Hydroxyethylene 1,1-diphosphonate, 2-phosphono-1,2,4-butane-tricarboxylic acid or their salts are most preferred.

Disintegrating agents or retarding agents are also generally used, which have the purpose of respectively accelerating or slowing down the disintegration of the layer in which they are incorporated.

By <<disintegration of a layer>> is meant the separation of the different components making up said layer relatively to the layer which is adjacent to it and the dissolution of these components. A method for measuring the disintegration time is described in detail later on.

The components mentioned above are used as a base for the composition of the detergent tablet. They are distributed in the different layers forming the tablet depending on constraints mentioned earlier, i.e. avoiding and possibly moving away the components, which should not interact with each other during storage of the tablet.

In the case of a detergent tablet for a dishwasher, moving the layer forming the enzymatic system away from the layer comprising the bleaching agents is particularly sought after. For example a layer comprising the rinsing system may for example be inserted between a layer comprising the enzymes and a layer comprising the bleaching agents.

The different components are also distributed according to the desired disintegration sequence. In particular, it is desirable that the rinsing system be activated at the end of the washing cycle, or at very least after the action of the cleaning agents such as the enzymatic system. To do this, the layer forming the rinsing system should comprise the retarding agents required for retarding dissolution. It may further be provided that the rinsing system forms a particular layer, placed at the centre of the five-layer tablet, so that it can only be dissolved after dissolution of the layers which surround it. Among the four layers surrounding the layer forming the rinsing system, there will be for example a layer forming the enzymatic system, a layer comprising the bleaching agents and a layer comprising the bleaching agent activators.

Preferably, the tablet will be formed so that the layer forming the enzymatic system and the layer forming the rinsing system have a disintegration time of less than and of more than 7 minutes, respectively.

The disintegration time is determined with the following method: a beaker filled with 5 litters of tap water with a hardness of 7-15° TH (water hardness is given by the hydrotimetric titer measured in ° TH, with 1° TH-10 mg.1⁻¹ CaCO₃) at 55° C. with a stirring rate of 150 revolutions/minute. Stirring is obtained by means of a mechanical stirrer and a stirring impeller. The detergent tablet is placed in a basket which is then introduced into the beaker of water while starting the stopwatch. The time is read on the stopwatch every time a layer of the tablet is totally dissolved, which corresponds to the disintegration time of said layer. The pH of the water during dissolution of the tablet may also be noted by means of a pH-meter.

All the disintegration times indicated in the present document are measured according to the method which has just been described.

In a particular embodiment of the invention, the five layers of the detergent tablet all have different compositions. For example they may comprise the enzymes, the bleaching agent activator, the bleaching agent, the rinsing additives and the protective additives, respectively. In addition to these basic components, each of the layers may further comprise surfactants, builders, sequestering agents, disintegrating agents and retarding agents, depending on the desired disintegration of the layer, and optionally dyes.

As already indicated, it is preferable that the layer forming the enzymatic system not be in contact with the layer comprising the bleaching agent. With this, it is possible to avoid chemical interactions between the enzymatic system and the bleaching agents, which increases chemical stability of the tablet and accordingly improves its storage.

For the same reasons, it may be appropriate that the layer comprising the bleaching agent be not in contact with the layer comprising the bleaching agent activator.

From the disintegration sequence point of view, it is preferable that the layer forming the enzymatic system be one of the two outer layers of the tablet. In the same way, as this has already been specified, the layer forming the rinsing system is preferably the median layer of the stack formed by the five superimposed layers.

According to a preferred embodiment, the detergent tablet comprises the five layers mentioned earlier, these layers being superimposed in the following order:
a layer forming the enzymatic system, next
a layer comprising the bleaching agent activator, next
a layer forming the rinsing system, next
a layer comprising the bleaching agent, next
a layer forming the protection system.

It should be noted that protective additives may be added in several layers of the tablet.

We shall now give a few examples of detergent tablets for a dishwasher, with five layers with different compositions and also with a different layer order, with the disintegration times of each of the layers.

### EXAMPLE 1

Example 1 corresponds to a phosphate-free tablet with two layers containing a bleaching agent.

The order of the layers and the composition of each of the layers of the tablet are given by Table 1 below. In this table, the amounts of each component are given as a mass percentage relatively to the mass of the relevant layer.

TABLE 1

| | | Mass percentage |
|---|---|---|
| Layers | Components | in each layer |
| Layer 1: | Protease | 5.4 |
| Layer containing the | | (active |
| enzymatic system | | enzymes: 0.46%) |
| | Amylase | 2.9 |
| | | (active |
| | | enzymes: 0.041%) |
| | Non-ionic surfactant | 2.4 |
| | Silica | 1.3 |
| | Acrylic homopolymer | 12.2 |
| | Sodium bicarbonate | 21.7 |
| | Sodium carbonate | 23.2 |
| | Sodium silicate | 15.1 |
| | Sodium citrate | 6.6 |
| | Cellulose | 9 |
| | Dye | 0.2 |
| Layer 2: | Benzotriazole | 1 |
| A layer containing | Phosphonate | 4.9 |
| protective additives | Sodium silicate containing a | 19.5 |
| for the dishwasher | polymer and a zinc salt | |
| and dishes and a | Sodium bicarbonate | 10.7 |
| portion of the | Sodium silicate | 13.7 |
| bleaching agent | Non-ionic surfactant | 4.6 |
| | Silica | 2.4 |
| | Sodium percarbonate | 34.2 |
| | Cellulose | 8.3 |
| | Perfume | 0.5 |
| | Dye | 0.2 |
| Layer 3: | Sodium percarbonate | 39 |
| A layer containing a | Sodium bicarbonate | 13.1 |
| portion of the | Polyethylene glycol | 7.7 |
| bleaching agent | Sodium citrate | 40.2 |
| Layer 4: | Polyethylene glycol | 9.8 |
| A layer containing | Dense sodium carbonate | 8.8 |
| the rinsing system | Light sodium carbonate | 8.8 |
| | Sodium bicarbonate | 19.5 |
| | Sodium silicate containing a | 21.7 |
| | polymer | |
| | Sodium citrate | 21 |
| | Non-ionic surfactant | 3.2 |
| | Silica | 1.6 |
| | Phosphonate | 5.5 |
| | Dye | 0.1 |
| Layer 5: | TAED | 14.6 |
| A layer containing | Sodium bicarbonate | 21.9 |
| the bleaching agent | Dense sodium carbonate | 4.9 |
| activator | Light sodium carbonate | 4.9 |
| | Sodium citrate | 22.2 |
| | Sodium silicate containing a | 18.3 |
| | polymer | |
| | Non-ionic surfactant | 3.6 |
| | Silica | 1.7 |
| | Polyethylene glycol | 5.5 |
| | Cellulose | 2.4 |

The weight of each of the layers of the tablet is 4.1 grams.

The hardness of the tablets, as measured by means of a hardness-meter MTS Synergie 100, range 500N/C (registered trademark), is 80-110 Newtons.

The dissolution times of each of the layers, with the method described earlier, are illustrated in Table 2 below.

TABLE 2

| Layers | Dissolution times (minutes) | pH |
|---|---|---|
| T = 0 | 0 | 7.40 |
| Layer 1 containing the | 4 | 9.71 |
| enzymatic system | | |
| Layer 2 containing protective | 6 | 9.78 |
| additives for the dishwasher | | |
| and dishes and a portion of | | |
| the bleaching agent | | |
| Layer 3 containing a portion | 7 | 9.8 |
| of the bleaching agent | | |
| Layer 4 containing the rinsing | 9 | 9.69 |
| system | | |
| Layer 5 containing the | 8 | 9.69 |
| bleaching agent activator | | |

The sequenced dissolution of the layers of the tablet is noted down. The layer containing the enzymatic system has a dissolution time of less than 7 minutes and the layer containing the rinsing system has a dissolution time of more than 7 minutes.

### EXAMPLE 2

Example 2 corresponds to a phosphate-free tablet with a single layer containing the bleaching agent.

The order of the layers and the composition of each of the layers of the tablet are given by Table 3 below. In this table, the amounts of each component are given as a mass percentage relatively to the mass of the relevant layer.

TABLE 3

| | | Mass percentage |
|---|---|---|
| Layers | Components | in each layer |
| Layer 1: | Protease | 5.4 |
| Layer containing the | | (active |
| enzymatic system | | enzymes: 0.46%) |
| | Amylase | 2.9 |
| | | (active |
| | | enzymes: 0.041%) |
| | Non-ionic surfactant | 2.4 |
| | Silica | 1.3 |
| | Acrylic homopolymer | 12.2 |
| | Sodium bicarbonate | 21.7 |
| | Sodium carbonate | 23.2 |
| | Sodium silicate | 15.1 |
| | Sodium citrate | 6.6 |
| | Cellulose | 9 |
| | Dye | 0.2 |
| Layer 2: | Benzotriazole | 1 |
| A layer containing | Phosphonate | 4.9 |
| protective additives | Sodium silicate containing a | 19.5 |
| for the dishwasher | polymer and a zinc salt | |
| and dishes and a | Sodium bicarbonate | 11.3 |
| portion of the | Sodium silicate | 13.7 |
| bleaching agent | Sodium citrate | 33.6 |
| | Non-ionic surfactant | 4.6 |
| | Silica | 2.4 |
| | Cellulose | 8.3 |
| | Perfume | 0.5 |
| | Dye | 0.2 |
| Layer 3: | Sodium percarbonate | 73.2 |
| A layer containing a | Sodium bicarbonate | 12.5 |
| portion of the | Polyethylene glycol | 7.7 |
| bleaching agent | Sodium citrate | 6.6 |
| Layer 4: | Polyethylene glycol | 9.8 |
| A layer containing | Dense sodium carbonate | 8.8 |
| the rinsing system | Light sodium carbonate | 8.8 |
| | Sodium bicarbonate | 19.5 |
| | Sodium silicate containing a | 21.7 |
| | polymer | |
| | Sodium citrate | 21 |
| | Non-ionic surfactant | 3.2 |
| | Silica | 1.6 |
| | Phosphonate | 5.5 |
| | Dye | 0.1 |
| Layer 5: | TAED | 14.6 |
| A layer containing | Sodium bicarbonate | 21.9 |
| the bleaching agent | Dense sodium carbonate | 4.9 |
| activator | Light sodium carbonate | 4.9 |
| | Sodium citrate | 22.2 |
| | Sodium silicate containing a | 18.3 |
| | polymer | |
| | Non-ionic surfactant | 3.6 |
| | Silica | 1.7 |
| | Polyethylene glycol | 5.5 |
| | Cellulose | 2.4 |

The weight of each layer of the tablet is 4.1 grams.

The hardness of the tablets, as measured by means of a hardness-meter MTS Synergie 100, range 500N/C (registered trademark), is 90-110 Newtons.

The dissolution times of each of the layers, measured with the method described earlier, are illustrated in Table 4 below.

TABLE 4

| Layers | Dissolution times (minutes) | | pH |
|---|---|---|---|
| T = 0 | 0 | | 7.49 |
| Layer 1 containing the | 3 | | 9.75 |
| enzymatic system | | | |
| Layer 2 containing protective | 9 | | 9.84 |
| additives for the dishwasher | | | |
| and dishes and a portion of | | | |
| the bleaching agent | | | |
| Layer 3 containing the | 12 | min 30 | 9.85 |
| bleaching agent | | | |
| Layer 4 containing the rinsing | 11 | min 30 | 9.83 |
| system | | | |
| Layer 5 containing the | 6 | | 9.75 |
| bleaching agent activator | | | |

The sequenced dissolution of the layers of the tablet is again noted down. The layer containing the enzymatic system has a dissolution time of less than 7 minutes and the layer containing the rinsing system has a dissolution time of more than 7 minutes.

### EXAMPLE 3

Example 3 corresponds to a phosphate-free tablet with a single layer containing the bleaching agent.

The order of the layers and the composition of each of the layers of the tablet are given by Table 5 below. In this table, the amounts of each component are given as a mass percentage relatively to the mass of the relevant layer.

TABLE 5

| | | Mass percentage |
|---|---|---|
| Layers | Components | in each layer |
| Layer 1: | Protease | 5.4 |
| Layer containing the | | (active |
| enzymatic system | | enzymes: 0.46%) |
| | Amylase | 2.9 |
| | | (active |
| | | enzymes: 0.041%) |
| | Non-ionic surfactant | 2.4 |
| | silica | 1.3 |
| | Acrylic homopolymer | 12.2 |
| | Sodium bicarbonate | 21.7 |
| | Sodium carbonate | 23.2 |
| | Sodium silicate | 15.1 |
| | Sodium citrate | 6.6 |
| | Cellulose | 9 |
| | Dye | 0.2 |
| Layer 2: | TAED | 14.6 |
| Layer containing the | Sodium bicarbonate | 21.9 |
| bleaching agent | Dense sodium carbonate | 4.9 |
| activator | Light sodium carbonate | 4.9 |
| | Sodium citrate | 22.2 |
| | Sodium silicate containing a | 18.3 |
| | polymer | |
| | Non-ionic surfactant | 3.6 |
| | Silica | 1.7 |
| | Polyethylene glycol | 5.5 |
| | Cellulose | 2.4 |
| Layer 3: | Polyethylene glycol | 9.8 |
| Layer containing the | Dense sodium carbonate | 8.8 |
| rinsing system | Light sodium carbonate | 8.8 |
| | Sodium bicarbonate | 19.5 |
| | Sodium silicate containing a | 21.7 |
| | polymer | |
| | Sodium citrate | 21 |
| | Non-ionic surfactant | 3.2 |
| | Silica | 1.6 |
| | phosphonate | 5.5 |
| | Dye | 0.1 |
| Layer 4: | Sodium percarbonate | 73.2 |
| Layer containing the | Sodium percarbonate | 12.5 |
| bleaching agent | Polyethylene glycol | 7.7 |
| | Sodium citrate | 6.6 |
| Layer 5: | Benzotriazole | 1 |
| Layer containing | Phosphonate | 4.9 |
| protective additives | Sodium silicate containing a | 19.5 |
| for the dishwasher | polymer and a zinc salt | |
| and dishes | Sodium bicarbonate | 11.3 |
| | Sodium silicate | 13.7 |
| | Sodium citrate | 33.6 |
| | Non-ionic surfactant | 4.6 |
| | Silica | 2.4 |
| | Cellulose | 8.3 |
| | Perfume | 0.5 |
| | Dye | 0.2 |

The weight of each of the layers of the tablet is 4.1 grams.

The hardness of the tablets, as measured with a hardness-meter MTS Synergie 100 range 500N/C (registered trademark), is 100-110 Newtons.

The dissolution times of each the layers, measured with the method described earlier, are illustrated in Table 6 below.

TABLE 6

| Layers | Dissolution times (minutes) | | pH |
|---|---|---|---|
| T = 0 | 0 | | 7.40 |
| Layer 1 containing the | 5 | | 9.65 |
| enzymatic system | | | |
| Layer 2 containing the | 10 | | 9.91 |
| bleaching agent activator | | | |
| Layer 3 containing the rinsing | 9 | min 30 | 9.91 |
| system | | | |
| Layer 4 containing the | 7 | | 9.84 |
| bleaching agent | | | |
| Layer 5 containing the | 2 | min 30 | 9.65 |
| protective additives for the | | | |
| dishwasher and dishes | | | |

The sequenced dissolution of the layers of the tablet is noted down once again. The layer containing the enzymatic system has a dissolution time of less than 7 minutes and the layer containing the rinsing system has a dissolution time of more than 7 minutes.

In this configuration of the tablet, the enzymatic layer is separated from the layer containing the bleaching agent by the layer containing the rinsing system and by the layer containing the bleaching agent activator. Further, the layer containing the bleaching agent activator is not in contact with the layer containing the bleaching agent. With this configuration it is possible to obtain better stability of the tablet during storage.

This tablet further has good washing performances.

As indicated earlier, the tablet preferably comprises from 0.003 to 2% by mass (relatively to the total mass of the tablet) of active enzymes.

There exists a certain number of tests with which the amount of active enzymes present in a detergent tablet may be quantified, for example from tracking its washing efficiency.

We shall describe a particular test below with which this enzymatic activity may be measured from different type of stains.

This test is performed on a dishwasher of the Vedette brand, model Vedette VLA 830, with the Modul'up program, the steps of which are the following:
Washing at 50° C. (4.7 L) for 20 min, next
Cold rinsing (4.6 L) for 5 min, next
Hot rinsing (4,4 L) for 20 min, next
Drying for 15 min.

FIG. 1 is a graph illustrating the time course of the temperature during this washing program.

The test is performed in hard water at 15° TH and with a soil ballast. Standardized soil tiles (supplier: Centre For Testmaterials BV) are used. These are resin tiles on which soil is deposited. 7 different tiles are used for studying several types of stains, and therefore the efficiency of the enzymes and of the bleaching agent:
Oxidizable stains: tea (ref: DM 11), red wine (ref: DM 51),
Starch based stains: corn starch (ref: DM 76), rice (ref: DM 78),
Protein stains: egg (ref: DM 21), egg-milk (ref: DM 31), meat (ref: DM 91).

The tiles are then put into the dishwasher. Two tiles of each stain are used every time.

Each tile is measured by means of a spectrocolorimeter (portable spectrocolorimeter Mercury SN 1130 (registered trademark) before washing and then at the end of the dishwasher program. The measured calorimetric deviations (ΔE*) provide an evaluation of the efficiency of the protease on protein stains, the efficiency of the amylase on starch based stains and the efficiency of the bleaching agent on oxidizable stains. For a given stain, the larger the calorimetric deviation, the more the tablet comprises corresponding active enzymes.

The spectrocolorimeter determines the Cartesian coordinates of the light emitted by the observed object, i.e.:
L*: luminosity (−dark/light+)→scale from 0 to 100,
The a* component (−green/red +)→scale from −100 to +100,
The b* component (−blue/yellow +)→scale from −100 to +100.

The apparatus gives the calorimetric coordinates of the plate before washing (standard) and then of the washed plate (sample).

By knowing the 3 quantities (L*,a*,b*), it is possible to calculate the calorimetric deviation between the sample and the standard according to the following formula:

ΔE* =\sqrt{(ΔL*)²+(Δa*)²+(Δb*)²}

For each sample, an average value of ΔE * is determined over several measurements.

The test which has just been described was conducted with several detergent tablets in which the layer forming the enzymatic system was changed so as to vary the amount of active enzymes.

The tablet used corresponds to the tablet of Example 3 described earlier. Only the composition of layer 1 comprising the enzymatic system was modified, so as to have 0% of enzymes, 0.05% of enzymes, 0.5% of enzymes and 5% of enzymes, respectively (Examples 4-7), these percentages being mass percentages relative to the total mass of the tablet.

The exact compositions of the layer 1 comprising the enzymatic system for each example are summarized in the following Table 7:

TABLE 7

| Components of | | | | |
|---|---|---|---|---|
| the layer | | | | |
| containing the | Mass percentage in the layer | | | |
| enzymatic system | Example 4 | Example 5 | Example 6 | Example 7 |
| Protease | 0 (active | 0.16 (active | 1.62 (active | 16.26 (active |
| | enzymes: | enzymes: | enzymes: | enzymes: |
| | 0) | 0.014) | 0.14) | 1.4) |
| Amylase | 0 (active | 0.09 (active | 0.87 (active | 8.75 (active |
| | enzymes: | enzymes: | enzymes: | enzymes: |
| | 0) | 0.0013) | 0.012) | 0.12) |
| Non-ionic | 2.4 | 2.4 | 2.4 | 2.44 |
| surfactant | | | | |
| Silica | 1.3 | 1.34 | 1.3 | 1.3 |
| Acrylic | 12.2 | 12.2 | 12.2 | 12.2 |
| homopolymer | | | | |
| Sodium | 21.7 | 21.7 | 21.7 | 21.7 |
| bicarbonate | | | | |
| Sodium carbonate | 31.4 | 31.2 | 29 | 6.44 |
| Sodium silicate | 15.2 | 15.11 | 15.11 | 15.11 |
| Sodium citrate | 6.6 | 6.6 | 6.6 | 6.6 |
| Cellulose | 9 | 9 | 9 | 9 |
| Dye | 0.2 | 0.2 | 0.2 | 0.2 |

The washing efficiency of the tablet on various dirt stain marks is summarized in Table 8 below:

TABLE 8

| Stains | Egg | Egg-milk | Meat | Rice | Corn starch |
|---|---|---|---|---|---|
| Analyzed enzyme | Protease | | | Amylase | |
| ΔE* Example 4 | 5.42 | 6.23 | 9.26 | 11.42 | 10.93 |
| ΔE* Example 5 | 6.43 | 7.59 | 10.15 | 13.76 | 11.67 |
| ΔE* Example 6 | 10.61 | 7.8 | 13.45 | 24.93 | 22.76 |
| ΔE* Example 7 | 33.81 | 25.29 | 14.60 | 62.68 | 66.62 |

With this test it is possible to properly evaluate the active enzyme content of the tablet as the result is all the more significant since the amount of active enzymes is large. In particular, very significant efficiency is seen for Examples 6 and 7, which correspond to tablets comprising 0.5 and 5% by mass of enzymes, respectively, i.e. about 0.03 and 0.3% by mass of active enzymes.

Further, with Example 5, which corresponds to a tablet comprising 0.05% by mass of enzymes, i.e. about 0.003% by mass of active enzymes, it is seen that with the shown efficiency test, the enzymatic activity of the tablet may be described and quantified in spite of the very small amount of active enzymes present in the tablet.

The reader will have understood that many modifications may be made without materially departing from the new teachings and advantages described herein. Accordingly, all the modifications of this type are intended to be incorporated within the scope of the five-layer detergent tablet according to the invention, and of its manufacturing method.

1. A detergent tablet comprising five layers superimposed on each other, with at least three layers among the five layers having different compositions.

2. The detergent tablet of claim 1, wherein the tablet has a mass comprised between 15 and 30 grams.

3. The detergent tablet of of claim 1, wherein the tablet has a height comprised between 5 and 50 mm.

4. The detergent tablet of any of claim 1, wherein each layer has a height comprised between 1 and 20 mm.

5. The detergent tablet of any of claim 1, wherein the tablet has a breaking strength comprised between 70 and 180 Newtons.

6. The detergent tablet of claim 1, wherein the tablet has a density comprised between 1 and 5 g/cm³.

7. The detergent tablet of claim 1, wherein the tablet comprises less than 4% by mass of phosphates, the mass percentage being relative to the total mass of the tablet.

8. The detergent tablet of claim 1, wherein the tablet comprises:
between 0.003 and 2% by mass of active enzymes;
between 10 and 99% by mass of detergency adjuvants;
between 0.05 and 40% by mass of surfactants;
between 1 and 30% by mass of bleaching agents;
between 0.5 and 10% by mass of bleaching agent activators, the mass percentages being relative to the total mass of the tablet.

9. The detergent tablet of claim 1, wherein the three layers having different compositions comprise a bleaching agent, a bleaching agent activator and enzymes for forming an enzymatic system, respectively.

10. The detergent tablet of claim 9, wherein the layer comprising the enzymes is not in contact with the layer comprising the bleaching agent, and in that the layer comprising the bleaching agent is not in contact with the layer comprising the bleaching agent activator.

11. The detergent tablet of claim 9, wherein the tablet further comprises rinsing additives for forming a rinsing system, and protective additives for forming a protection system of items to be cleaned with the detergent tablet.

12. The detergent tablet of claim 9, wherein the tablet comprises one or two layers comprising a bleaching agent.

13. The detergent tablet of claim 11, wherein each of the five layers has a different composition, the five layers comprising the bleaching agent, the bleaching agent activator, the enzymes, the rinsing additives and the protective additives, respectively.

14. The detergent tablet of claim 1, wherein the tablet comprises a layer with a disintegration time of less than 7 minutes, and a layer with a disintegration time of more than 7 minutes.

15. The detergent tablet of claim 14, taken wherein the layer with a disintegration time of less than 7 minutes is the layer forming the enzymatic system.

16. The detergent tablet of claim 15, wherein the layer forming the enzymatic system comprises disintegrating agents for accelerating disintegration of the layer.

17. The detergent tablet of claims 14 wherein the layer with a disintegration time of more than 7 minutes is the layer forming the rinsing system.

18. The detergent tablet of claim 17, wherein the layer forming the rinsing system comprises retarding agents for slowing down disintegration of the layer.

19. A method for manufacturing the detergent tablet of claim 1 comprising the following successive steps:
forming mixtures corresponding to the respective compositions of the five layers of the tablet;
depositing on a support the mixture corresponding to the composition of the first layer, and forming the first layer by compression;
depositing on the first layer the mixture corresponding to the composition of the second layer, and forming the second layer by compression of the formed assembly;
depositing on the second layer the mixture corresponding to the composition of the third layer, and forming the third layer by compression of the formed assembly;
depositing on the third layer the mixture corresponding to the composition of the fourth layer, and forming the fourth layer by compression of the formed assembly;
depositing on the fourth layer the mixture corresponding to the composition of the fifth layer, and forming the fifth layer by compression of the formed assembly.

20. The method of claim 19, wherein forming the first, second, third and fourth layers is achieved by compressing the formed assembly at a compression value comprised between 1,000 kN/m² and 10,000 kN/m², and in that forming the fifth layer is achieved by compressing the formed assembly at a compression value comprised between 8,000 kN/m² and 25,000 kN/m².
